(19) United States
(12) Patent Application Publication
(10) Pub. No.: US 2006/0067201 A1
(43) Pub. Date: Mar. 30, 2006

(54) Single-base DVD

(75) Inventor: Ying-Tsang Chang, Shulin City (TW)

Correspondence Address: APEX JURIS, PLLC, 13194 EDGEWATER LANE NORTHEAST, SEATTLE, WA, 98125, US

(73) Assignee: Guann Way Technologies Co., Ltd., Shulin City (TW)

(21) Appl. No.: 11/266,093

(22) Filed: Nov. 2, 2005

Related U.S. Application Data
(63) Continuation-in-part of application No. 10/808,851, filed on Mar. 25, 2004, now abandoned.

(51) Int. Cl. G11B 3/70; G11B 7/24

(52) U.S. Cl. 369/272.1; 369/275.1

(57) ABSTRACT

A single-base DVD has a disk base and a recording layer. The disk base composed of polycarbonate is 0.6 millimeter (mm) thick and has a center, two faces, an edge, a centering hole, an outer flange and an inner flange. The centering hole is in the center of the disk base. The outer flange and the inner flange are both 0.6 millimeter (mm) thick and formed on one face of the disk base, and the outer flange is near the edge while the inner flange is near the centering hole. The recording layer is sprayed on the disk base between the outer flange and the inner flange. The single-base DVD only has one disk base and help can reduce the production cost to manufacture it.

### BACKGROUND OF THE INVENTION

1. Field of the Invention

The present invention relates to a single-base DVD, especially to a single-base DVD that can help reduce the production cost.

2. Description of the Related Art

With reference to FIG. 2, a conventional VCD comprises a disk base (20) and a recording layer (22). The disk base (20) made of polycarbonate is 0.6 millimeter (mm) thick and has two faces and a centering hole (21). The centering hole (21) is formed in the center of the disk base (20). The recording layer (22) is spread on one face of the disk base (20) and is used to store data.

Since the maximum memory capacity of a conventional VCD is only about 800 MB and is not enough to meet the demands of the fast-moving information age, the DVD (Digital Versatile Disk) with 4 GB memory capacity was developed.

With reference to FIG. 3, a conventional DVD comprises a first disk base (30), a second disk base (31), a recording layer (32) and a centering hole (33). The first disk base (30) and the second disk base (31) are both made of polycarbonate and are combined with each other to produce a DVD. The thickness of the first disk base (30) and the second disk base (31) is 0.6 mm respectively to comply with the thickness requirement for a DVD player. The recording layer (32) is spread between the first disk base (30) and the second disk base (31), and the centering hole (33) is in the center of the DVD.

As the price of polycarbonate is high, the cost to manufacture the conventional DVD with two disk bases is more than that of a VCD. A manufacturer must also face additional production costs, as making two disk bases requires two different kinds of molds.

To overcome the shortcomings, the present invention provides a single-base DVD to obviate or mitigate the aforementioned problems.

### SUMMARY OF THE INVENTION

The main objective of the present invention is to provide a single-base DVD that can help reduce the production cost.

The single-base DVD comprises a disk base and a recording layer. The disk base composed of polycarbonate is 0.6 millimeter (mm) thick and has a center, two faces, an edge, a centering hole, an outer flange and an inner flange. The centering hole is in the center of the disk base. The outer flange and the inner flange are both 0.6 mm thick and formed on one face of the disk base, and the outer flange is near the edge while the inner flange is near the centering hole. The recording layer is sprayed on the disk base between the outer flange and the inner flange.

The single-base DVD only has one disk base and a manufacturer can save on the material expense. The addition of the outer flange and the inner flange makes the single-base DVD have enough thickness to conform to a conventional DVD player.

Other objectives, advantages and novel features of the invention will become more apparent from the following detailed description when taken in conjunction with the accompanying drawings.

### BRIEF DESCRIPTION OF THE DRAWINGS

FIG. 1 is a cross-sectional side view of a single-base DVD in accordance with the present invention.

FIG. 2 is a cross-sectional side view of a conventional VCD in accordance with the prior art.

FIG. 3 is a cross-sectional side view of a conventional DVD in accordance with the prior art.

### DETAILED DESCRIPTION OF THE PREFERRED EMBODIMENT

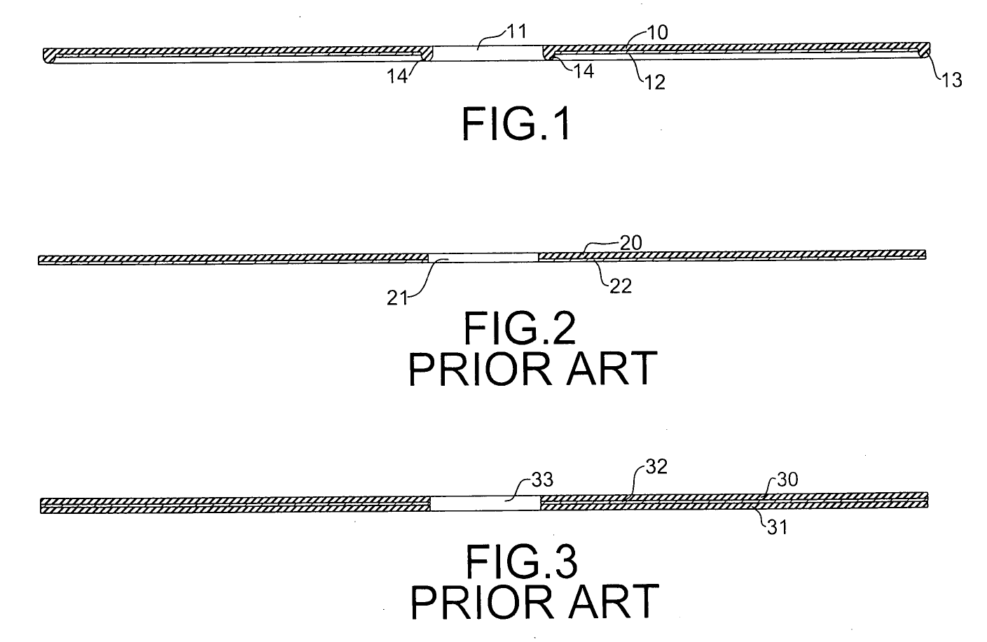

With reference to FIG. 1, a single-base DVD in accordance with the present invention comprises a disk base (10) and a recording layer (12).

The disk base (10) is composed of polycarbonate, is 0.6 millimeter (mm) thick and comprises a center (not numbered), two faces (not numbered), an edge (not numbered), a centering hole (11), an outer flange (13) and an inner flange (14).

The centering hole (11) is formed in the center of the disk base (10). The outer flange (13) is formed on one face of the disk base (10) and near the edge, and it is 0.6 mm thick. The inner flange (14) is formed on the same face of the disk base (10) with the outer flange (13) near the centering hole (11), and is also 0.6 mm thick. The recording layer (12) is sprayed on the disk base (10) between the outer flange (13) and the inner flange (14).

The single-base DVD as described has the following advantages. Since the single-base DVD only has one disk base, a manufacturer can save on polycarbonate material and reduce the production cost. The outer flange (13) and the inner flange (14) are both 0.6 mm thick and make the DVD have 1.2 mm thick and conform to the thickness requirement for a DVD player. The manufacturer needs only one mold when manufacturing the single-base DVD and can reduce the mold expense.

Even though numerous characteristics and advantages of the present invention have been set forth in the foregoing description together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A single-base DVD comprising
a disk base being 0.6 millimeter (mm) thick and composed of polycarbonate and comprising
a center;
two faces;
an edge;
a centering hole formed in the center;
an outer flange being 0.6 millimeter (mm) thick and formed on one face near the edge; and
an inner flange being 0.6 millimeter (mm) thick and formed on the same face with the outer flange near the centering hole; and
a recording layer sprayed on the disk base between the outer flange and the inner flange.
